(19) United States
(12) Patent Application Publication
(10) Pub. No.: US 2023/0325967 A1
(43) Pub. Date: Oct. 12, 2023

(54) ACCOMMODATIONS FOR XR DEVICES

(71) Applicant: Meta Platforms Technologies, LLC, Menlo Park, CA (US)

(72) Inventors: Chris ROJAS, Seattle, WA (US); Joshuah VINCENT, Seattle, WA (US); Paul Armistead HOOVER, Bothell, WA (US)

(73) Assignee: Meta Platforms Technologies, LLC, Menlo Park, CA (US)

(21) Appl. No.: 18/336,616

(22) Filed: Jun. 16, 2023

Related U.S. Application Data
(60) Provisional application No. 63/381,206, filed on Oct. 27, 2022.
(60) Provisional application No. 63/380,291, filed on Oct. 20, 2022.
(60) Provisional application No. 63/353,263, filed on Jun. 17, 2022.

(51) Int. Cl. G06T 1/60; G06T 19/00

(52) U.S. Cl. CPC G06T 1/60; G06T 19/006

(57) ABSTRACT

In some implementations, the disclosed systems and methods can provide a set of triggers that cause the degradation system to degrade output graphics. In further implementations, the disclosed systems and methods can display a virtual object in an artificial reality environment to a user, where the displayed virtual object corresponds to the captured video. In yet further implementations, the disclosed systems and methods can evaluate one or more contexts corresponding to activity of a user while using the artificial reality device to view images.

### CROSS REFERENCE TO RELATED APPLICATIONS

This application claims priority to U.S. Provisional Application No. 63/353,263 filed Jun. 17, 2022 and titled “Degradation of Output Graphics to Conserve Resources on an XR System,” 63/380,291 filed Oct. 20, 2022 and titled “Image Dimming in Artificial Reality” and 63/381,206 filed Oct. 27, 2022 and titled “Virtual Object Display with Dynamic Angular Position Adjustment.” Each patent application listed above is incorporated herein by reference in their entireties.

### BACKGROUND

Artificial reality (XR) devices are becoming more prevalent. As they become more popular, the applications implemented on such devices are becoming more sophisticated. Augmented reality (AR) and Mixed Reality (MR) applications can provide interactive 3D experiences that combine the real world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. In AR and MR, such interactions can be observed by the user through a head-mounted display (HMD).

Artificial reality, extended reality, or extra reality (collectively “XR”) is a form of reality that has been adjusted in some manner before presentation to a user, which may include, e.g., virtual reality (VR), augmented reality (AR), mixed reality (MR), hybrid reality, or some combination and/or derivatives thereof. Various XR environments exist that can display virtual objects to users. However, generating an intuitive experience for a user remains and elusive goal. For example, two-dimensional virtual objects often display information in conventional XR environments, but interactions with two-dimensional virtual objects can lack real-world similarity.

Battery operated devices for the Internet of Things, such as those used in implementing artificial reality (XR) systems and environments, are increasingly the focus of energy conservation. This is particularly the case as these systems and environments become more complex, requiring increased amounts of power during their operation(s). As can be understood, implementations for conserving energy resources in relation to XR devices can afford users opportunities to operate those devices for longer durations and/or with heightened levels of intensity.

### SUMMARY

Aspects of the present disclosure are directed to degradation of output graphics to reduce load on an artificial reality (XR) system. Because XR systems face numerous problems in terms of power consumption, bandwidth, temperature, and processing power, it is desirable to minimize the amount of resources needed without drastically affecting the user experience. Some implementations can provide a set of triggers that cause the degradation system to degrade output graphics. The degradation system can map the triggers to particular degradations to proactively conserve or reactively reduce power consumption, bandwidth, temperature, and/or processing power on one or more devices of the XR system.

Aspects of the present disclosure are directed to dynamically moving a virtual object display in accordance with movement of a captured object. Video of an object can be captured by camera(s). The captured object may move within the field of vision of the camera(s) such that the object's distance from the camera(s) changes. Implementations can display a virtual object in an artificial reality environment to a user, where the displayed virtual object corresponds to the captured video. For example, the virtual object can be a two-dimensional representation of a video of a person. Implementations can dynamically move the display of the virtual object in correspondence with the object's distance from the camera(s). For example, the displayed virtual object can be dynamically moved closer to the user when the object moves closer to the camera(s) and further from the user when the object moves away from the camera(s).

Aspects of the present disclosure are directed to conserving energy needed to power an artificial reality device. To achieve the conservation, a contextual dimming system can evaluate one or more contexts corresponding to activity of a user while using the artificial reality device to view images. Depending on the evaluated context or contexts for the activity, the system can automatically adjust an amount of lighting provided to the images to effect an energy conscious level of illumination still enabling the images to be adequately viewed.

### BRIEF DESCRIPTION OF THE DRAWINGS

FIG. 1 is a wire diagram illustrating an XR system which can be used in some implementations of the present technology.

FIG. 2 is a flow diagram illustrating a process for degrading output graphics to conserve resources on an XR system according to some implementations of the present technology.

FIG. 3A is a conceptual diagram illustrating a system of degradation actions that can be taken for various triggers occurring on an HMD according to some implementations of the present technology.

FIG. 3B is a conceptual diagram illustrating a system of degradation actions that can be taken for various triggers occurring on a core processing component according to some implementations of the present technology.

FIG. 3C is a conceptual diagram illustrating a system of degradation actions that can be taken for various triggers occurring on a wearable device according to some implementations of the present technology.

FIGS. 4A-4D are screenshots of views from an HMD in which one or more components of an XR system are applying various degradation actions according to some implementations of the present technology.

FIG. 5A is a screenshot of a view of a menu from an HMD in which one or more components of an XR system are beginning to overheat according to some implementations of the present technology.

FIG. 5B is a screenshot of a view of a menu from an HMD in which one or more components of an XR system are applying degradation to lower component temperature according to some implementations of the present technology.

FIG. 6 is an example of views of an image applying reduced texture level of detail according to some implementations of the present technology.

FIG. 7 is an example of views of an image applying foveated vignette according to some implementations of the present technology.

FIG. 8 is a diagram of a captured object and a display of a corresponding virtual object.

FIG. 9 is a diagram of a captured object after movement and movement of the display of the corresponding virtual object.

FIG. 10 is a conceptual diagram that illustrates position and size adjustments of a displayed virtual object in accordance with movement of a captured object.

FIG. 11 is a flow diagram illustrating a process used in some implementations for dynamically positioning a virtual display in response to detected motion.

FIG. 12 is a conceptual diagram illustrating an exemplary XR image in a first contextual dimming scenario.

FIG. 13 is a conceptual diagram illustrating an exemplary XR image in a second contextual dimming scenario.

FIG. 14 is a flow diagram illustrating a process used in some implementations for conserving energy for an XR device according to one or more contexts of user activity.

FIG. 15 is a block diagram illustrating an overview of devices on which some implementations of the present technology can operate.

FIG. 16 is a block diagram illustrating an overview of an environment in which some implementations of the present technology can operate.

### DESCRIPTION

Because XR systems face numerous problems in terms of power consumption, bandwidth, temperature, and processing power, it is desirable to minimize the amount of resources needed without drastically affecting the user experience. Thus, some implementations provide a degradation system that can degrade output graphics to proactively conserve XR system resources and/or to reactively reduce load on the XR system. Some implementations can provide a set of triggers that cause the degradation system to degrade output graphics.

Triggers for degrading graphics can include, for example, a temperature of one or more components of the XR system exceeding a threshold, screen fill on the XR display device exceeding a threshold, processing power needed exceeding a threshold, power consumption on one or more components of the XR system exceeding a threshold, environmental lighting conditions, limited wireless bandwidth between components of the XR system, connectivity strength between components of the XR system, storage capacity of one or more components of the XR system, errors on one or more components of the XR system, relocalization failure/misaligned world on a HMD, etc., or any combination thereof.

In response to one or more of the triggers, some implementations can apply one or more degradations to output graphics based on the trigger. Some implementations can have a map of triggers to particular degradations based on the desired action, e.g., reduction in power consumption, temperature, bandwidth, processing speed, etc. The degradations can include, for example, one or more of dimming, desaturating, reducing framerate/pausing animation, applying foveated vignette, applying green LED only, removing fills, reducing texture resolution, using imposters, reducing polygon count, applying blur, entering light or dark mode, compressing content, glinting content (i.e., simplifying the content), applying near clip plane (i.e., clipping graphics that are too close to the HMD), degrading to bounding box, degrading to object outline, clipping the field-of-view, reducing dynamic lighting, and any combination thereof. Such techniques are known to those skilled in the XR and graphics processing arts.

As an example of a dimming degradation method being applied according to some implementations, an HMD can display a virtual 3D chessboard overlaid on a real-world table in a living room at 100% brightness while the user is interacting with it. When the user selects a menu, the HMD can display the menu overlaid on the chessboard, but dim the chessboard in the background to a brightness of 25%. In addition, the HMD can create and display a 2D representation of the chessboard (referred to herein as an “imposter”), and pause virtual play on the chessboard. Such degradations can result in power, heat, and bandwidth savings on one or more components of the XR system.

In another example of a color reduction degradation method being applied according to some implementations, an HMD can display virtual 3D characters in full RGB color overlaid on a real-world outdoor environment. When the HMD begins to overheat, it can display a warning, and degrade the virtual characters to outlines in green LED only. Such a degradation can result in lowered temperature and less processing power on one or more components of the XR system.

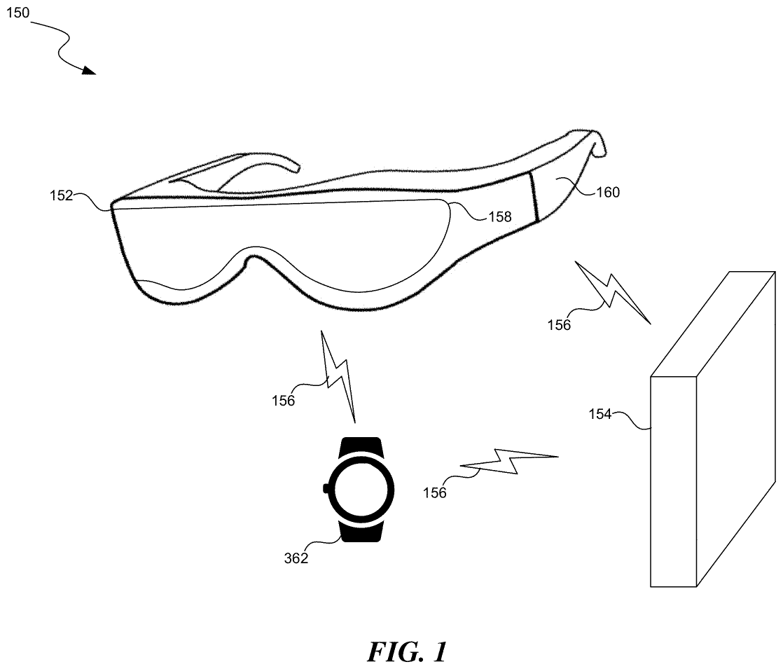

FIG. 1 is a wire diagram of a mixed reality HMD system 150 (also referred to herein as an XR system) which includes a mixed reality HMD 152, a core processing component 154, and a wearable device 162. The mixed reality HMD system 150 can be an example of an XR system as described further herein. The mixed reality HMD 152, the core processing component 154, and the wearable device 162 can communicate via a wireless connection (e.g., a 60 GHz link) as indicated by link 156. In other implementations, the mixed reality system 150 includes a headset only, without an external compute device or includes other wired or wireless connections between the mixed reality HMD 152, the core processing component 154, and the wearable device 162. In still other implementations, the mixed reality system 150 can include only a headset and an external compute device. The mixed reality HMD 152 includes a pass-through display 158 and a frame 160. The frame 160 can house various electronic components (not shown) such as light projectors (e.g., LASERs, LEDs, etc.), cameras, eye-tracking sensors, MEMS components, networking components, etc.

The projectors can be coupled to the pass-through display 158, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 154 via link 156 to HMD 152. Controllers in the HMD 152 can convert the image data into light pulses from the projectors, which can be transmitted via the optical elements as output light to the user's eye. The output light can mix with light that passes through the display 158, allowing the output light to present virtual objects that appear as if they exist in the real world.

The HMD system 150 or any of its components can include motion and position tracking units, cameras, light sources, etc., which allow the HMD system 150 to, e.g., track itself in 3DoF or 6DoF, track portions of the user (e.g., hands, feet, head, or other body parts), map virtual objects to appear as stationary as the HMD 152 moves, and have virtual objects react to gestures and other real-world objects.

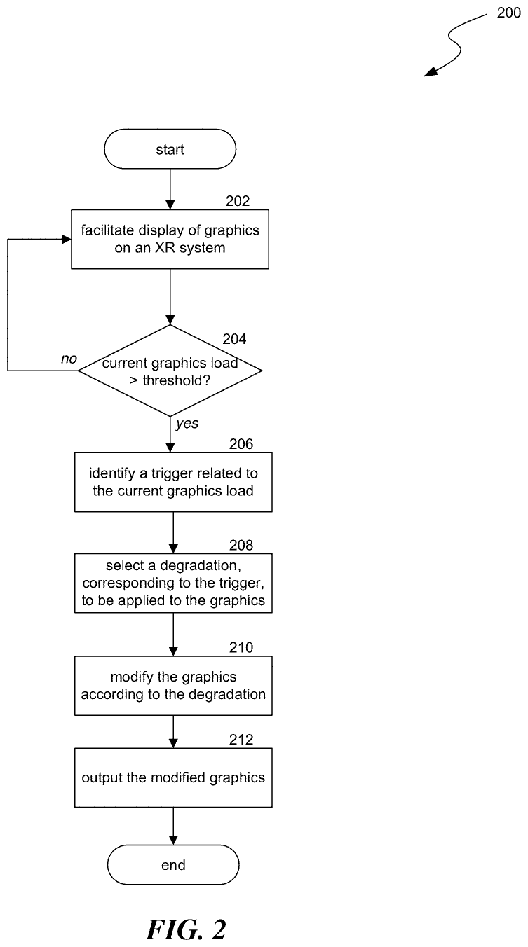

FIG. 2 is a flow diagram illustrating a process 200 used in some implementations for degrading output graphics to conserve resources on an XR system. In some implementations, process 200 can be performed “just in time,” e.g., as graphics are being output on an HMD or other XR display device. Process 200 can be executed by, for example, a server, a degradation system, or any component of an XR system as described herein.

At block 202, process 200 can facilitate display of graphics on an XR system. If process 200 is being executed on an HMD, process 200 can display the graphics on the HMD. If process 200 is being executed on a core processing component, process 200 can cause the graphics to be displayed on the HMD by way of a network connection, as described further herein.

At block 204, process 200 can determine whether the current graphics load on the XR system exceeds a threshold for one or more parameters. The parameters can include, for example, power consumption, bandwidth, temperature, processing speed, etc. If process 200 determines that the current graphics load on the XR system does not exceed a threshold, process 200 can return to block 202 and continue to facilitate display of graphics on the XR system. If process 200 determines that the current graphics load on the XR system exceeds a threshold, process 200 can proceed to block 206. At block 206, process 200 identifies a trigger related to the current graphics load.

The trigger can include approaching or exceeding a maximum power consumption, a maximum bandwidth, a maximum temperature, a maximum available processing speed, etc., and any combinations thereof. Other specific examples of triggers can include, a temperature of one or more components of the XR system exceeding a threshold, screen fill on the XR display device exceeding a threshold, processing power needed exceeding a threshold, power consumption on one or more components of the XR system exceeding a threshold, environmental lighting conditions, limited wireless bandwidth between components of the XR system, connectivity strength between components of the XR system, storage capacity of one or more components of the XR system, errors on one or more components of the XR system, relocalization failure/misaligned world on the XR display device, etc., or any combination thereof.

At block 408, process 400 can select a degradation, corresponding to the trigger, to be applied to the graphics. Process 200 can map the triggers to particular degradations to remedy the trigger (as discussed below), e.g., to reduce bandwidth consumption, power consumption, and/or temperature of one or more components of the XR system. The degradations can include, for example, one or more of dimming, desaturating, reducing framerate/pausing animation, applying foveated vignette, applying green LED only, removing fills, reducing texture resolution, using imposters, reducing polygon count, applying blur, entering light or dark mode, compressing content, glinting content, applying near clip plane, degrading to bounding box, degrading to object outline, clipping the field-of-view, reducing dynamic lighting, or any combination thereof.

At block 210, process 200 can modify the graphics according to the degradation. For example, process 200 can apply image editing techniques to the graphics directly. In some implementations, process 200 can cause image editing techniques to be applied to the graphics through graphics data being provided to the HMD in order for the HMD to render and display the modified graphics.

At block 212, process 200 can output the modified graphics. In some implementations in which process 200 is executed on an HMD, process 200 can display the modified graphics on the HMD. In some implementations in which process 200 is executed on an external core processing component as described further herein, process 200 can transmit data associated with the modified graphics to the HMD for rendering and display on the HMD.

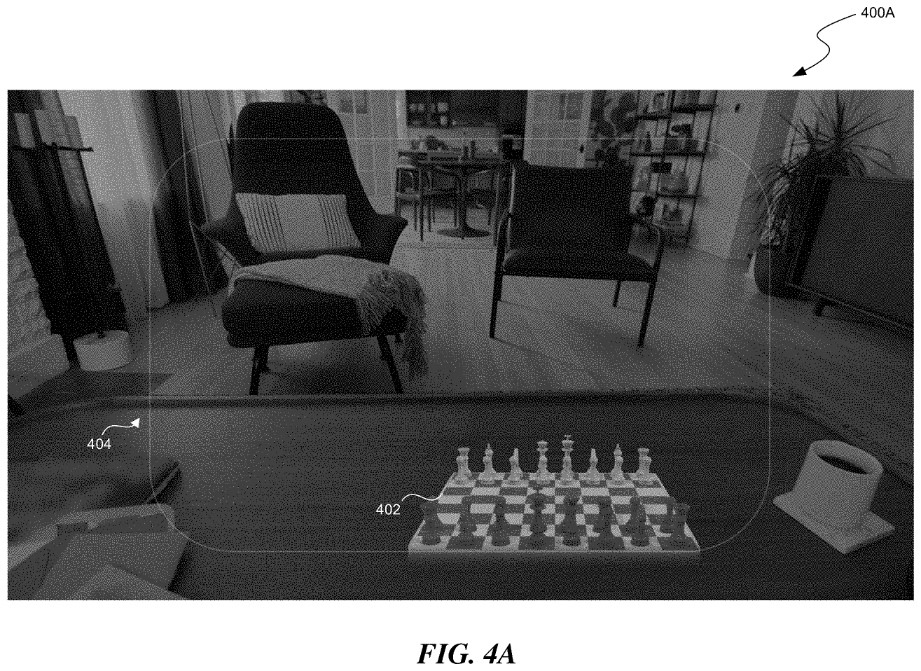

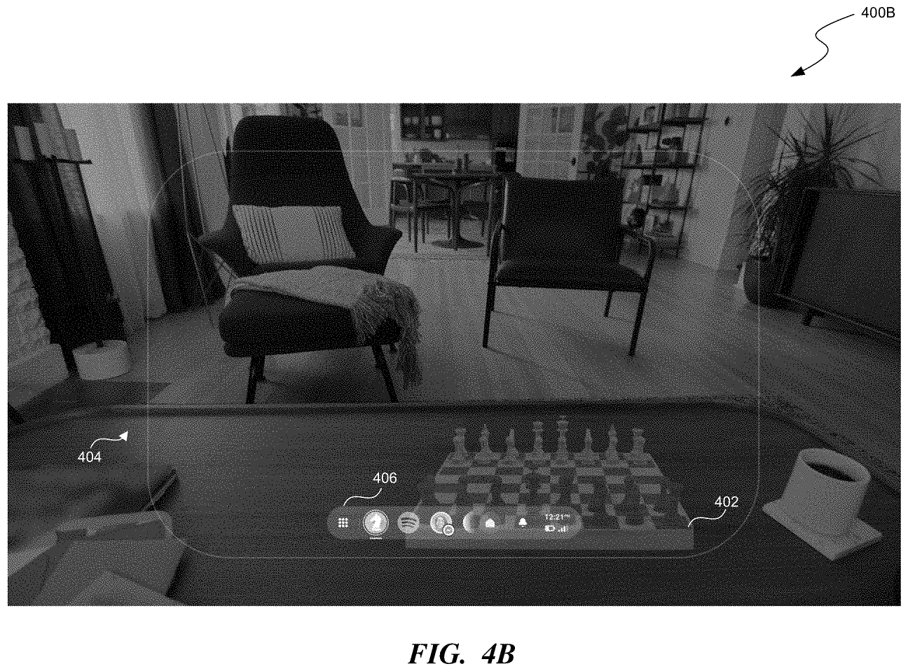

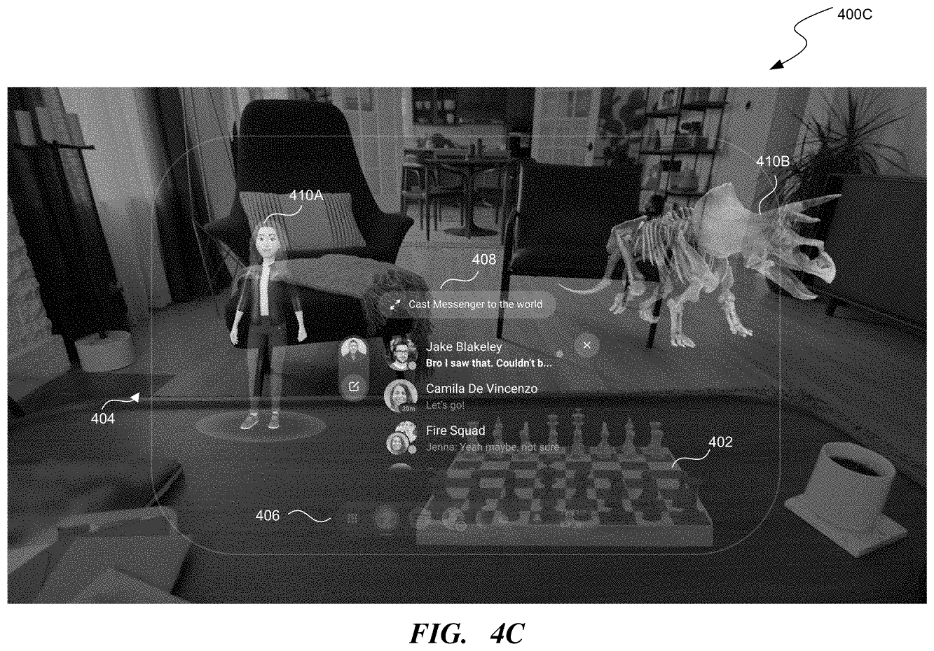

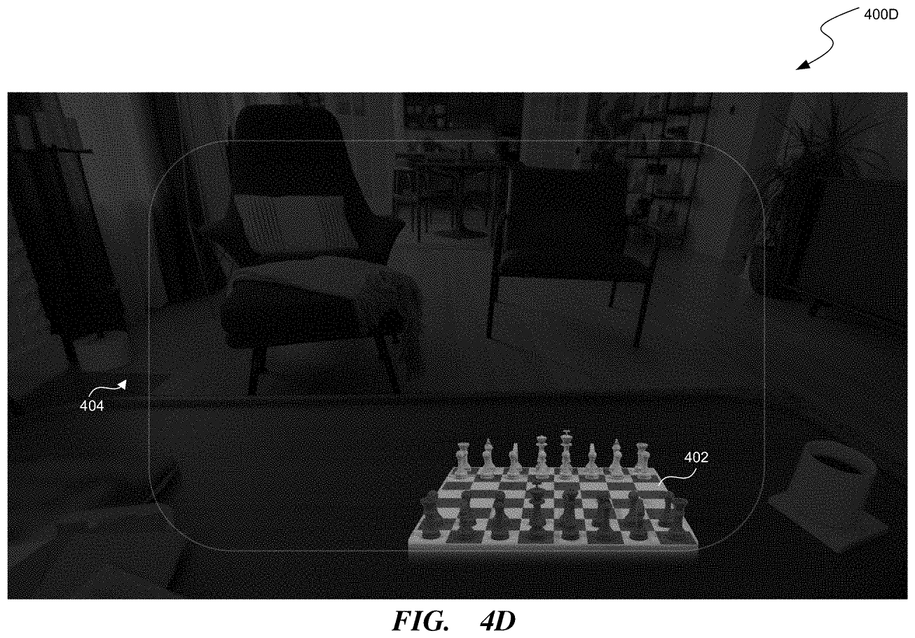

Although blocks 204-212 are illustrated as having one iteration in FIG. 4, it is contemplated that blocks 204-212 can be repeated multiple times, periodically, in response to a trigger, or continuously. For example, blocks 204-212 can be repeated until the current graphics load no longer exceeds a threshold and/or until display of the graphics is terminated, such as by deactivating or powering off the HMD or other component in the XR system.

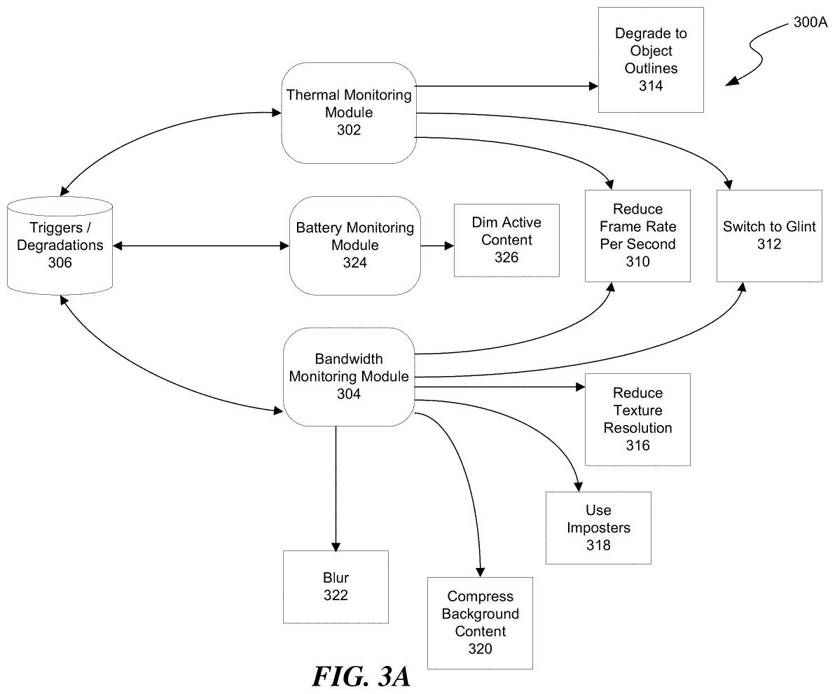

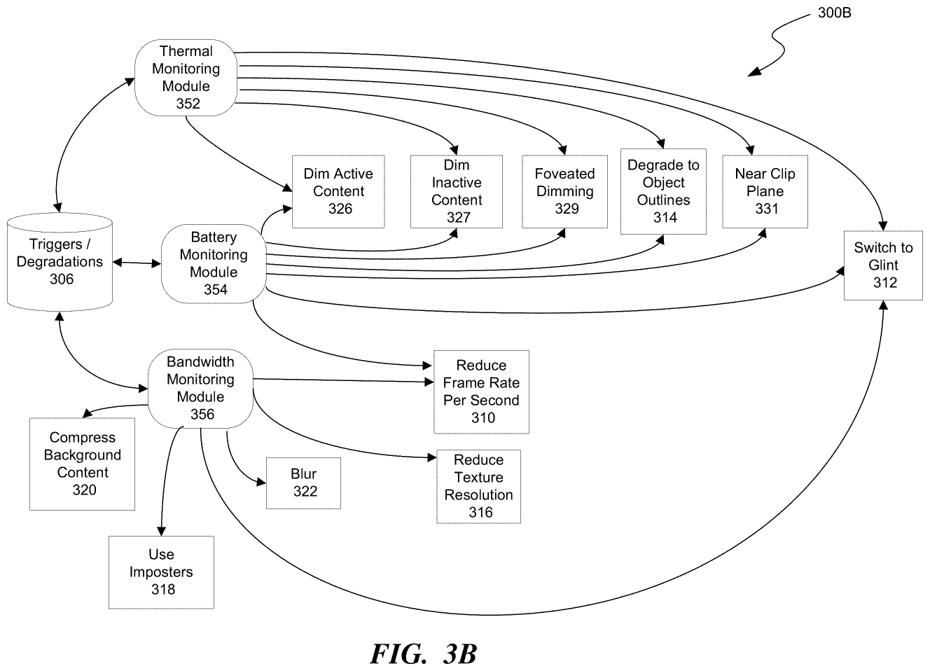

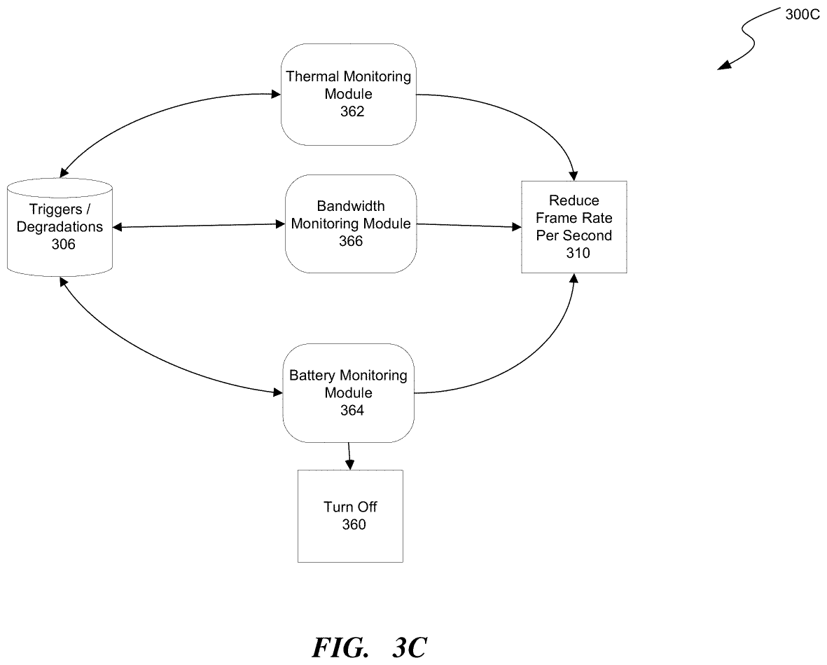

FIG. 3A is a conceptual diagram illustrating a system 300A of degradation actions that can be taken for various triggers occurring on an HMD according to some implementations of the present technology. System 300A includes a thermal monitoring module 302, a battery monitoring module 324, and a bandwidth monitoring module 304, which can be located internally to or externally from the HMD. Thermal monitoring module 302 can monitor the temperature of the HMD and determine whether it has exceeded an acceptable threshold. Battery monitoring module 324 can monitor the remaining battery level of the HMD, as well as the speed at which the battery level is diminishing in some implementations. Bandwidth monitoring module 304 can monitor the bandwidth usage of the HMD and determine whether it has exceeded an acceptable threshold.

Thermal monitoring module 302, battery monitoring module 324, and bandwidth monitoring module 304 can access trigger data and degradation data from storage 306. Thermal monitoring module 302, battery monitoring module 324, and bandwidth monitoring module 304 can use the trigger data to determine whether their respective monitored attribute is outside of an acceptable range. The trigger data can be mapped to the degradation data in storage 306, such that particular triggers are associated with degradations that will address the trigger.

For example, thermal monitoring module 302 can monitor the temperature of components of the XR system and determine from trigger data in storage 306 that it has exceeded a threshold. Thermal monitoring module 302 can obtain degradation data from storage 306 to select one or more degradations that will lower the temperature of the XR system. In this case, thermal monitoring module 302 can, in conjunction with a processor or other components of the XR system, degrade graphics to object outlines 314, switch to glint 312 (i.e., minimize and/or replace a graphic with a simpler representation, such as replacing a hologram with an avatar), and/or reduce frame rate per second 310 (including pausing animation or updates to the graphics).

Battery monitoring module 324 can monitor the battery level of the XR system and determine from trigger data in storage 306 that it is lower than a threshold. In some implementations, battery monitoring module 324 can determine from trigger data in storage 306 that the battery is being consumed too quickly, regardless of the battery level. Battery monitoring module 324 can obtain degradation data from storage 306 to select one or more degradations that will conserve the battery of the XR system. For example, battery monitoring module 324 can, in conjunction with a processor and other components of the XR system, dim active content 326 being displayed on the HMD.

Bandwidth monitoring module 304 can monitor the bandwidth usage of the XR system and determine from trigger data in storage 306 that it is higher than a threshold. Bandwidth monitoring module 304 can obtain degradation data from storage 306 to select one or more degradations that will lower bandwidth usage of the XR system. For example, bandwidth monitoring module 304 can, in conjunction with a processor and other components of the XR system, reduce frame rate per second 310 (including pausing animation or updates to the graphics), switch to glint 312, reduce texture resolution of the graphics 316, use imposters 318 (i.e., a 2D representation of 3D graphics), compress background content 320, and/or blur the graphics 322.

FIG. 3B is a conceptual diagram illustrating a system 300B of degradation actions that can be taken for various triggers occurring on a core processing component as described herein according to some implementations of the present technology. System 300B includes a thermal monitoring module 352, a battery monitoring module 354, and a bandwidth monitoring module 356, which can be located internally to or externally from the core processing component. Thermal monitoring module 352 can monitor the temperature of the core processing component and determine whether it has exceeded an acceptable threshold. Battery monitoring module 354 can monitor the remaining battery level of the core processing component, as well as the speed at which the battery level is diminishing in some implementations. Bandwidth monitoring module 356 can monitor the bandwidth usage of the core processing component and determine whether it has exceeded an acceptable threshold.

Thermal monitoring module 352, battery monitoring module 354, and bandwidth monitoring module 356 can access trigger data and degradation data from storage 306. Thermal monitoring module 352, battery monitoring module 354, and bandwidth monitoring module 356 can use the trigger data to determine whether their respective monitored attribute is outside of an acceptable range.

Thermal monitoring module 352 can monitor the temperature of the core processing component and determine from trigger data in storage 306 that it has exceeded a threshold. Thermal monitoring module 352 can obtain degradation data from storage 306 to select one or more degradations that will lower the temperature of the core processing component. In this case, thermal monitoring module 352 can, in conjunction with a processor or other components of the XR system, dim active content 326, dim XR system inactive content 327, apply foveated dimming 329, degrade graphics to object outlines 314, apply near clip plane 331 (i.e., clip graphics that are virtually too close to the HMD), and/or switch to glint 312.

Battery monitoring module 354 can monitor the battery level of the core processing component and determine from trigger data in storage 306 that it is lower than a threshold. In some implementations, battery monitoring module 354 can determine from trigger data in storage 306 that the battery is being consumed too quickly, regardless of the battery level. Battery monitoring module 354 can obtain degradation data from storage 306 to select one or more degradations that will conserve the battery of the core processing component. For example, battery monitoring module 354 can, in conjunction with a processor and other components of the XR system, dim active content 326, dim inactive content 327, apply foveated dimming 329, degrade graphics to object outlines 314, apply near clip plane 331, switch to glint 312 and/or reduce frame rate per second 310.

Bandwidth monitoring module 356 can monitor the bandwidth usage of the core processing component and determine from trigger data in storage 306 that it is higher than a threshold. Bandwidth monitoring module 356 can obtain degradation data from storage 306 to select one or more degradations that will lower bandwidth usage of the core processing component. For example, bandwidth monitoring module 356 can, in conjunction with a processor and other components of the XR system, reduce frame rate per second 310, reduce texture resolution of the graphics 316, blur the graphics 322, switch to glint 312, use imposters 318, and/or compress background content 320.

FIG. 3C is a conceptual diagram illustrating a system 3000 including degradation actions that can be taken for various triggers occurring on a wearable device as described herein according to some implementations of the present technology. System 3000 includes a thermal monitoring module 362, a battery monitoring module 364, and a bandwidth monitoring module 366, which can be located internally to or externally from the wearable device. Thermal monitoring module 362 can monitor the temperature of the wearable device and determine whether it has exceeded an acceptable threshold. Battery monitoring module 364 can monitor the remaining battery level of the wearable device, as well as the speed at which the battery level is diminishing in some implementations. Bandwidth monitoring module 366 can monitor the bandwidth usage of the wearable device and determine whether it has exceeded an acceptable threshold.

Thermal monitoring module 362, battery monitoring module 364, and bandwidth monitoring module 366 can access trigger data and degradation data from storage 306. Thermal monitoring module 362, battery monitoring module 364, and bandwidth monitoring module 366 can use the trigger data to determine whether their respective monitored attribute is outside of an acceptable range.

Thermal monitoring module 362 can monitor the temperature of the wearable device and determine from trigger data in storage 306 that it has exceeded a threshold. Thermal monitoring module 362 can obtain degradation data from storage 306 to select one or more degradations that will lower the temperature of the wearable device. In this case, thermal monitoring module 362 can, in conjunction with a processor or other components of the XR system, reduce frame rate per second 310.

Battery monitoring module 364 can monitor the battery level of the wearable device and determine from trigger data in storage 306 that it is lower than a threshold. In some implementations, battery monitoring module 364 can determine from trigger data in storage 306 that the battery is being consumed too quickly, regardless of the battery level. Battery monitoring module 364 can obtain degradation data from storage 306 to select one or more degradations that will conserve the battery of the core processing component. For example, battery monitoring module 364 can, in conjunction with a processor and other components of the XR system, reduce frame rate per second 310 and/or turn off the wearable device 360.

Bandwidth monitoring module 366 can monitor the bandwidth usage of the wearable device and determine from trigger data in storage 306 that it is higher than a threshold. Bandwidth monitoring module 366 can obtain degradation data from storage 306 to select one or more degradations that will lower bandwidth usage of the core processing component. For example, bandwidth monitoring module 366 can, in conjunction with a processor and other components of the XR system, reduce frame rate per second 310.

FIGS. 4A-4D are screenshots of views from an XR system in which one or more components of an XR system are applying various degradation actions according to some implementations of the present technology. FIG. 4A shows view 400A of a virtual 3D chessboard 402 overlaid onto a real-world background 404 (Chess image by Francesco Coldesina). Chessboard 402 is active and displayed at 100% brightness while the user is interacting with it.

FIG. 4B shows view 400B in which the user of the XR system has selected a menu 406 and is interacting with it. Because menu 406 is active, the XR system can display menu 406 at 100% brightness, but dim chessboard 402 to a brightness of 25% because it is inactive. The XR system can further display chessboard 402 as a reduced 2D representation (i.e., an imposter) and can pause updates to chessboard 402. Such degradations can result in power, heat, and bandwidth savings on one or more components of the XR system.

FIG. 4C shows a view 400C in which the user of the XR system has selected and is interacting with an application 408 from menu 406, but has also opened a number of additional virtual objects 410A-410B on the display. As more virtual objects 410A-410B are opened, the XR system can degrade virtual objects 410A-410B and application 408 even if they're active based on increased screen fill on the HMD. For example, the XR system can display virtual objects 410A-410B and application 408 with opacity and dimmed to a brightness of 50%. Because chessboard 402 and menu 406 are inactive, the XR system can continue to display them paused and at a brightness of 25%. Such degradations can result in power, heat, and bandwidth savings on one or more components of the XR system.

FIG. 4D shows a view 400D in which the user of the XR system returns to chessboard 402, but the ambient light in background 404 is very low. In view 400D, the XR system can display chessboard 402 at a brightness lower than 100%, e.g., 50%, because chessboard 402 can be easily viewed against a darker background.

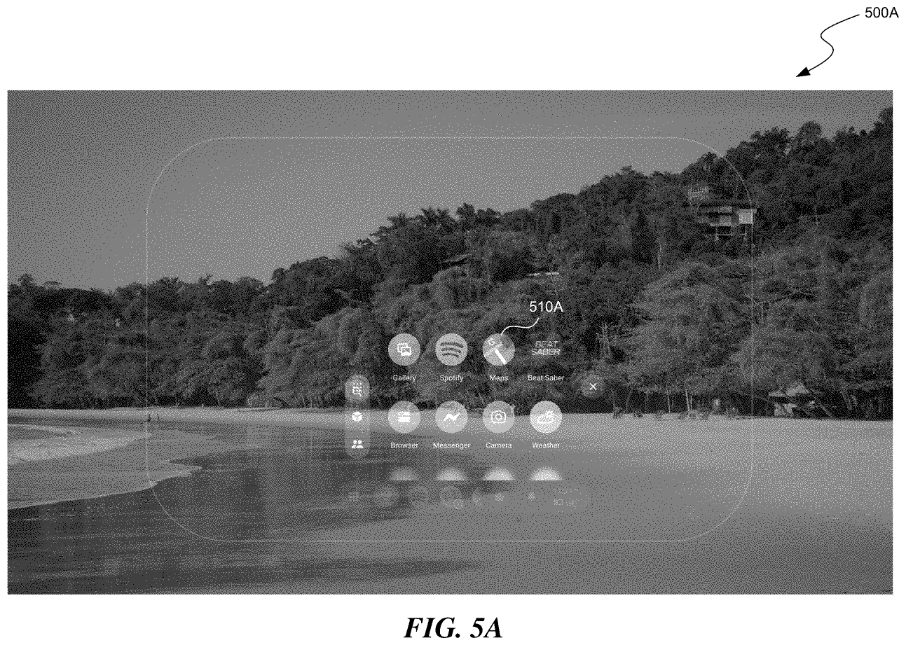

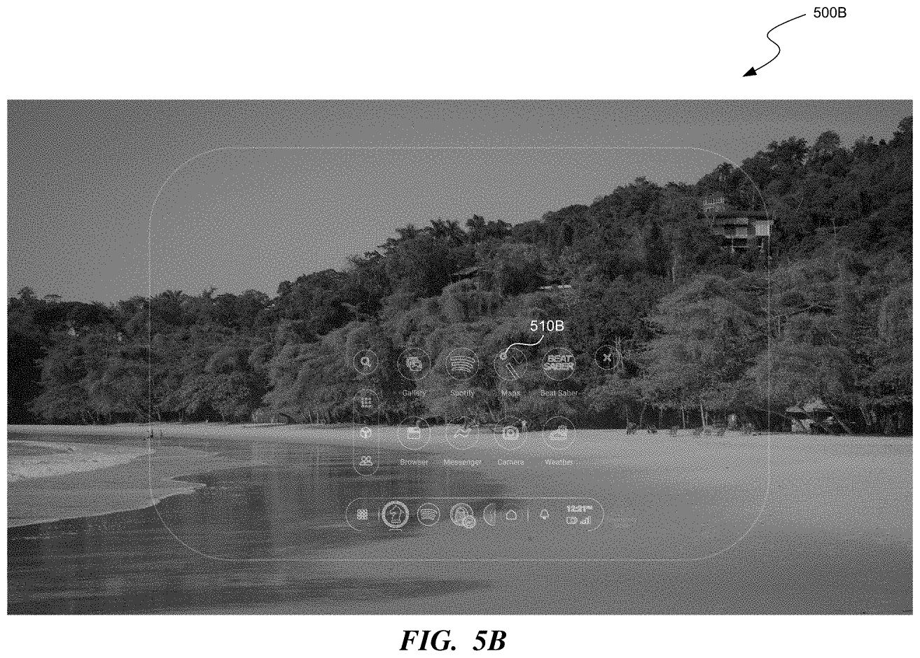

FIG. 5A is a screenshot of a view 500A of a menu 510A on an HMD in which one or more components of the XR system are reaching a threshold maximum temperature according to some implementations of the present technology. The HMD can dim the menu 510A in order to try to lower the temperature of the overheating component(s) of the XR system.

FIG. 5B is a screenshot of a view 500B of a menu 510B from an XR device that is applying degradation to lower the component temperature according to some implementations of the present technology. As the temperature of the overheating component(s) of the XR system continues to rise, the XR system can degrade menu 510A to menu 510B, which reduces the icons to outlines displayed with the green LED only. Such degradations can result in lowered temperature and less processing power on one or more components of the XR system.

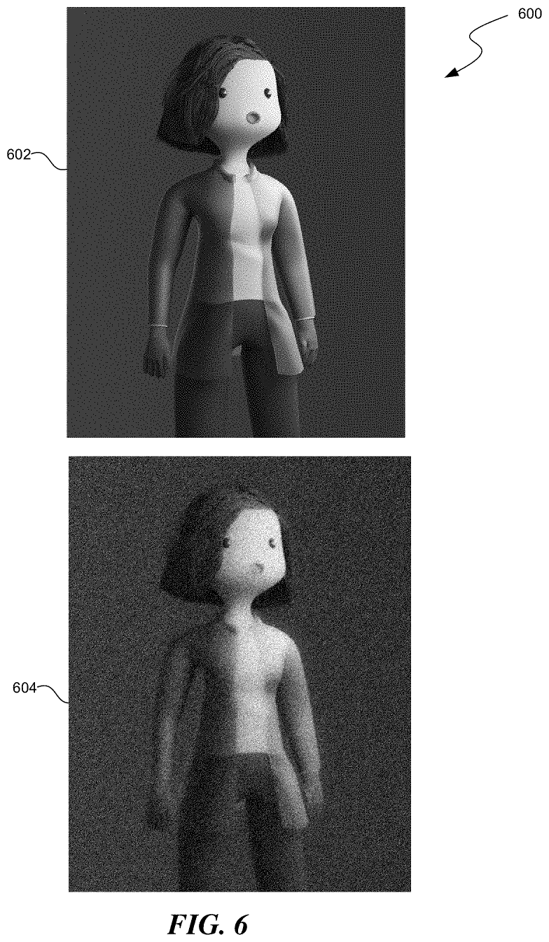

FIG. 6 is an example of views 600 of an image applying reduced texture level of detail according to some implementations of the present technology. Image 602 can be the original image without degradation being applied. Image 604 can be image 602 with 20% less texture level of detail. Because image 604 has less texture level of detail than image 602, display of image 604 can result in less bandwidth being used by one or more components of the XR system.

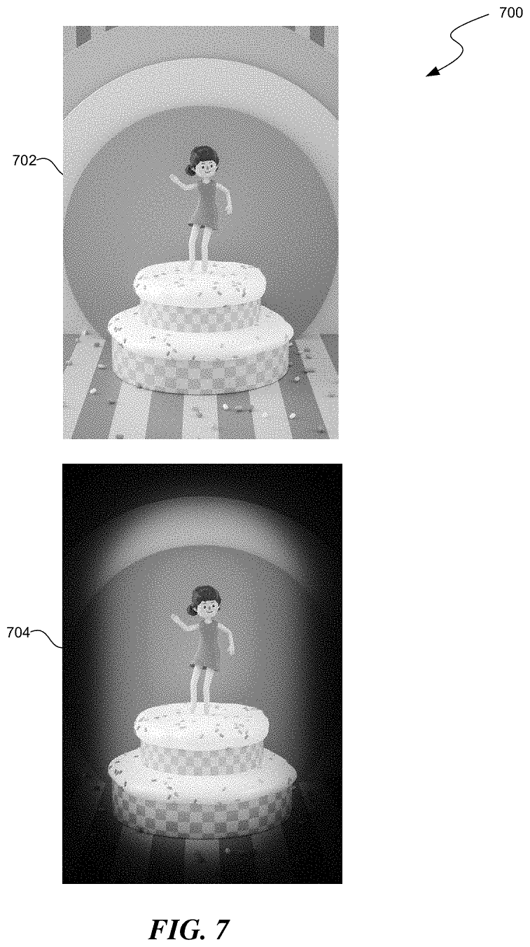

FIG. 7 is an example of views 700 of an image applying foveated vignette according to some implementations of the present technology. Image 702 can be the original image without degradation being applied. Image 704 can be image 702 with heavy foveated vignette applied. Because image 704 is vignetted with respect to image 702, display of image 704 can result in less bandwidth being used by one or more components of the XR system.

Aspects of the present disclosure are directed to dynamically moving a two-dimensional virtual object display in accordance with movement of a captured object. Implementations of a display device can display a virtual object that corresponds to captured video of a user (e.g., a person). For example, a first user can wear a display device (e.g., head mounted display) configured to receive video data of a second user. A capture device can capture video of the second user and transmit the video to the display device. The display device can generate a virtual object that represents the second user in the first user's field of view using the captured video (e.g., processed version of the captured video that isolates the second user). For example, the display device can display, to the first user, mixed reality, augmented reality, or artificial reality environment, where the light that enters the first user's eyes includes light from the real-world and light generated by the display device to display the virtual object to the user in an artificial reality environment. In some implementations, the virtual object can be a two-dimensional representation of the second user that corresponds to the captured video of the second user. For example, the capture of the video of the second user and the corresponding display of virtual object of the second user can occur in real-time or near real-time.

Implementations of a virtual object position manager can position the display of the two-dimensional virtual object according to a detected position for the captured object in the video. For example, the captured object can be a person that moves within the field of view of the video capture device (e.g., camera). The person can move towards the capture device or away from the capture device. Implementations can process the captured video to determine the captured object's position in the video frames and/or determine the captured object's distance from the video capture device. The virtual object position manager can dynamically move the display of the virtual object according to the determined position/distance of the captured object. For example, the virtual object position manager can move the virtual object closer to the user when the captured object moves close to the capture device and further from the user when the captured object moves further from the capture device. Implementations of the virtual object position manager dynamically repositions the virtual object along an angular/z-axis to move the virtual object towards or away from the user.

Implementations of the virtual object position manager that dynamically move a two-dimensional virtual object in accordance with a captured object's movements can provide an intuitive experience for a user. For example, when the captured object is a person, the two-dimensional virtual object representation of the person is dynamically moved towards the user (e.g., along an angular axis) when the person moves towards the camera capturing the video of the person and dynamically moved away from the user when the person moves away from the camera. For a two-dimensional display, the movement towards and away from the user (e.g., angular movement) generates an experience that incorporates the third dimension (e.g., z-axis movement). The third axis movement provides a presence and intuitive feel that conventional two-dimensional virtual object displays do not achieve. For example, virtual object movement within a user's three-dimensional space can trigger brain activity, such as an amygdala response, that is not triggered by conventional scaling of two-dimensional displays.

Implementations of the virtual object position manager also resize the virtual object according to z-axis/angular movement. For example, when a person captured by a camera moves towards the camera, the person becomes larger in the video frames (e.g., the person's head/body take up a larger proportion of the captured frames). If the two-dimensional virtual object that represents the video of the person were to be dynamically moved closer to the user without size rescaling, the person may grow very large from the user's point of view. This is because both the display of the virtual object moves closer to the user and the person grows larger (e.g., a larger proportion of the virtual object depicts the person's face/body). The virtual object position manager can dynamically resize the two-dimensional virtual object when moving the object along the angular axis to manage the virtual object's relative size from the user's perspective. For example, the virtual object can be scaled down in size when the displayed virtual object is dynamically moved closer to the user and the virtual object can be scaled up in size when the displayed virtual object is dynamically moved further from the user.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

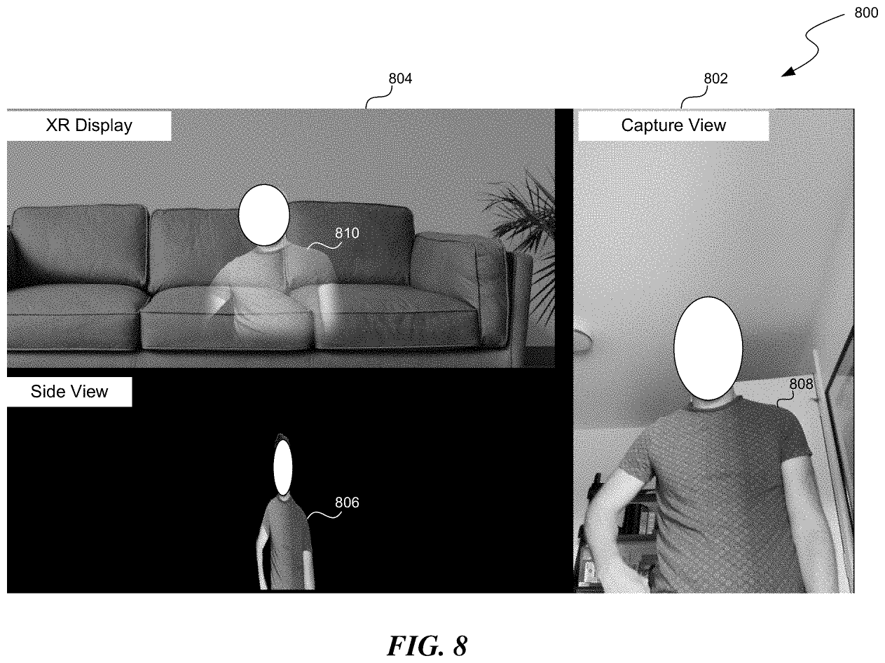

Implementations generate and dynamically move a virtual object in a user's field of view in coordination with the movements of a real-world object captured by an image capturing device. FIG. 8 is a diagram of a captured object and a display of a corresponding virtual object. Diagram 800 depicts video frame 802, XR display view 804, side view 806, real-world object 808, and virtual object 810. Video frame 802 can be a captured video frame that includes real-world object 808, in the illustrated example a person. XR display view 804 depicts virtual object 810, which corresponds to the captured video frames of real-world object 808. For example, XR display view 804 can display virtual object 810 to a user.

In some implementations, virtual object 810 is a two-dimensional object. Virtual object 810 can mirror movements by real-world object 808 (e.g., based on video frames captured by an image capturing device) as a flat two-dimensional display version of real-world object 808. In some implementations, the display location of virtual object 810 is based on the location of real-world object 808 in video frame 802. Side view 806 depicts a side view that shows an angular display location (e.g., z-display location) of virtual object 810 within the user's field of view.

In some implementations, the display location of virtual object 810 is dynamically moved according to movement by real-world object 808 towards or away from the capture device that captures video frame 802.

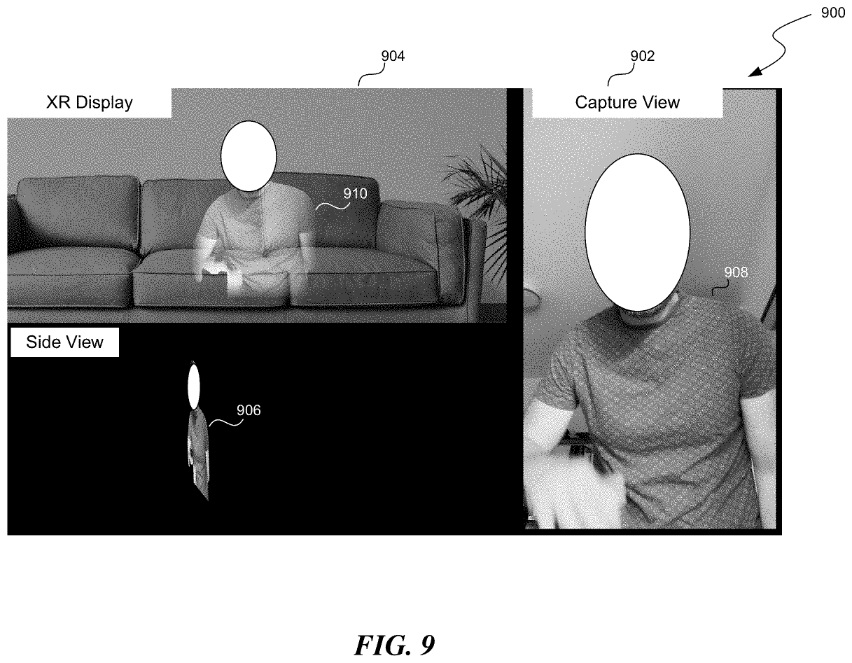

FIG. 9 is a diagram of a captured object after movement and movement of the display of the corresponding virtual object. Diagram 900 depicts video frame 902, XR display view 904, side view 906, real-world object 908, and virtual object 910. Video frame 902, XR display view 904, side view 906, real-world object 908, and virtual object 910 can be similar to the video frames discussed above, however in video frame 902 real-world object 908 has moved closer to the image capturing device that captures video frame 902, and virtual object 910 has been dynamically moved to correspond with the movement of real-world object 908.

For example, when real-world object 908 moves closer to the image capturing device, the display of virtual object 910 can be dynamically moved to a location closer to the user along an angular axis (e.g., z-axis). For example, side view 906 demonstrates a shift in the angular positioning of the display of virtual object 910 in comparison to the side view and the display of virtual object, discussed above. In some implementations, the display of virtual object 910 can be dynamically moved towards the user (e.g., along the angular axis) when real-world object 908 moves towards the image capturing device and dynamically moved away from the user when the real-world object 908 moves away from the image capturing device.

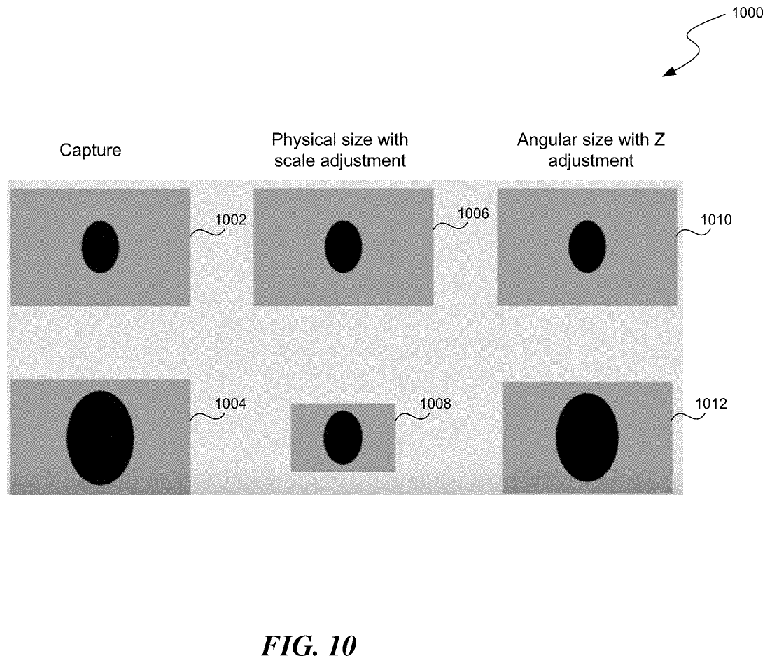

Implementations can also resize a displayed virtual object when performing angular/z-axis movement. FIG. 10 is a conceptual diagram that illustrates position and size adjustments of a displayed virtual object in accordance with movement of a captured object. Diagram 1000 includes capture frame 1002, post-movement capture frame 1004, unscaled virtual object 1006, scaled virtual object 1008, unadjusted virtual object 1010 and angular adjusted virtual object 1012.

Capture frame 1002 and post-movement capture frame 1004 illustrate an object, such as a face, in a video frame, where the face takes up a smaller proportion of the frame in capture frame 1002 and a larger portion of the frame in post-movement capture frame 1004. For example, a person captured (e.g., captured face) is further from the camera during the capture of capture frame 1002 and has moved closer to the camera during the capture of post-movement capture frame 1004. Implementations can alter the virtual object display to a user that corresponds to capture frame 1002 and post-movement capture frame 1004 in at least two ways, a scale adjustment and an angular/z-adjustment.

For example, the corresponding virtual object (e.g., two-dimensional virtual object) display can be dynamically moved closer to the user based on the object in post-movement capture frame 1004 being closer to the camera. However, this sole adjustment may cause the virtual object to change in a disorienting way from the perspective of the user. This is because both the virtual object gets closer to the user (and thus grows in size from the perspective of the user) and the face displayed by the virtual object grows larger (e.g., a larger proportion of the virtual object depicts the person's face). To mitigate this potentially disorienting effect, implementations can dynamically resize the two-dimensional virtual object when moving the object along the angular axis to manage the virtual object's relative size from the user's perspective. For example, the virtual object can be scaled down in size when the displayed virtual object is dynamically moved closer to the user and the virtual object can be scaled up in size when the displayed virtual object is dynamically moved further from the user.

Unscaled virtual object 1006 and scaled virtual object 1008 illustrate the scale change when an object (e.g., person's face) moves closer to the camera/video source. Unscaled virtual object 1006 may not undergo a scale transformation since the object/face in capture frame 1002 has not moved closer to the camera. Scaled virtual object 1008 may be scaled down in size since the object/face in post-movement capture frame 1004 has moved closer to the camera (and thus the corresponding virtual object will be dynamically moved closer to the user).

Unadjusted virtual object 1010 and angular adjusted virtual object 1012 illustrate the relative size change from a user perspective when an object (e.g., person's face) moves closer to the camera/video source and its corresponding virtual object is scaled down. Unadjusted virtual object 1010 may not undergo a scale transformation since the object/face in capture frame 1002 has not moved closer to the camera. Angular adjusted virtual object 1012 may be dynamically moved (along an angular/z-axis) closer to the user in correspondence with the object/face in post-movement capture frame 1004 moving closer to the camera. In this example, angular adjusted virtual object 1012 has already been scaled down in size (as reflect by scaled virtual object 1008).

A comparison between unadjusted virtual object 1010 and angular adjusted virtual object 1012 demonstrate the effect achieved by performing both the scale change and an angular adjustment. The object/face in angular adjusted virtual object 1012 appears, from the perspective of the user, larger than the object/face in unadjusted virtual object 1010. This corresponds to the proportion of the frame the object/face occupies in capture frame 1002 and post-movement capture frame 1004. Absent the rescaling (e.g., just performing the angular/z-axis adjustment) the object/face would appear much larger in an angular adjusted virtual object from the perspective of the user since the virtual object is dynamically moved closer to the user. The rescaling mitigates this effect and achieves an expected display change from the perspective of the user.

In some implementations, display of the virtual object can include effects to mitigate friction in the user experience caused by the scale and angular/z-axis adjustments. For example, one or more edges (e.g., top, bottom, sides, perimeter, etc.) of the displayed virtual object can be blurred, pixels near the edge of the virtual object can have a reduced resolution, or any other suitable effect can be implemented to improve the user's visual experience with a moving two-dimensional virtual object against a background.

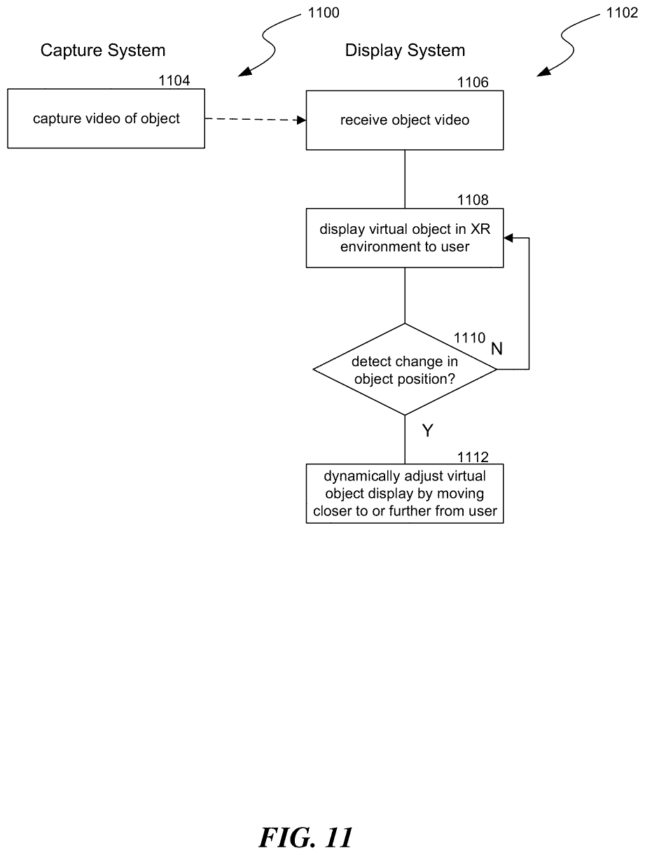

FIG. 11 is a flow diagram illustrating a process used in some implementations for dynamically positioning a virtual object display in response to detected motion. In some implementations, process 1100 can be performed by a video capture device (e.g., device with a camera) and process 1102 can be performed by a display device, such as a device capable of displaying an XR environment to a user. Example image capture devices include a XR system, a laptop with a camera, a smartphone, a smart speaker with a camera, a smart home device with a camera, or any other suitable image capture device. Example display devices include a XR system, a wearable device (e.g., head mounted displayed) that can generate virtual objects in a user's field of vision, or any other suitable display device capable of displaying a XR environment to a user.

At block 1104, process 1100 can capture video of an object. For example, a capture device can comprise one or more cameras that capture video frames of an object, such as a person or any other suitable object capable of movement. In some implementations, the captured object can be a person that moves within the camera(s) field of view, such as towards the camera and away from the camera. The capture device can transmit the video frames to a display device.

In some implementations, the capture device can process the video frames to isolate the object from the video frames. For example, the object can be a person, and one or more machine learning models (e.g., computer vision model(s)) can process the video frames to detect and track body and/or face segments. The tracked body/face of the person can then be extracted, for example using masks(s) generated by the tracking. In some implementations, processing the video can also include identifying a position for the person within the camera frames/field of vision. For example, one or more machine learning models can determine the person's distance from camera, position in a three-dimensional volume, or any other suitable object positioning.

In some implementations, the processed version of the video frames (e.g., extracted body/face portions) can be transmitted to the display device. The processed version of the video frames can include a position indicator that defines the object's position in the video frames (e.g., distance from camera, position relative to the camera field of view, etc.). In some implementations, the capture device can send the video frames to one or more external computing devices for processing, and the external computing device(s) can transmit the processed version of the video frames to the display device.

At block 1106, process 1102 can receive the object video. For example, the display device can receive the video frames or processed video frames that capture the object. In some implementations, the display device can process the received video, such as detecting and tracking body/face segments of a person and extracting these portions of the video. Processing the video can include detecting the object positioning within the video (e.g., distance from camera, position relative to the camera field of view, etc.). In some implementations, the received video can be a processed version of the video (e.g., comprising extracted body/face portions, object position, etc.).

At block 1108, process 1102 can display a virtual object to a user that correspond to the video frames of the object. For example, the virtual object can be a two-dimensional representation of captured video frames of a person. In some implementations, the display device can include one or more lenses that permit light to pass through the lenses into the user's eyes so that the user can view the real-world. The display device can also generate light that enters the user's eyes and renders the two-dimensional virtual object at a specific location of the XR environment.

At block 1110, process 1102 can detect a change in object position. For example, the received video can comprise a person captured by a camera. The person can move towards or away from the camera while the video is captured. A change in the person's distance from the camera can be detected as a change in the object's position. In some implementations, the person's position within the video frames can be received/determined, and a change in the object's position can be detected based on comparisons of the object's position in proximate/adjacent video frames. When a change in object position is detected, process 1102 can progress to block 1112. When a change in object position is not detected, process 1102 can loop back to block 1108, where the virtual object can continue to be displayed until a change in object position is detected.

At block 1112, process 1102 can dynamically move the display of the two-dimensional virtual object according to the position for the captured object in the video frame(s). For example, the captured object can be a person that moves within the field of view of the camera(s). The person can move towards the capture device or away from the capture device. The display of the virtual object can be dynamically moved according to the determined position/distance from camera of the captured object. For example, the virtual object can be dynamically moved closer to the user when the captured object moves closer to the camera and further from the user when the captured object moves further from the camera. Implementations dynamically reposition the virtual object along an angular/z-axis to move the virtual object towards or away from the user.

Implementations can resize the virtual object when performing z-axis/angular display adjustment. For example, when a person captured by a camera moves towards the camera, the person becomes larger in the video frames (e.g., the person's head/body take up a larger proportion of the captured frames). If the two-dimensional virtual object that represents the video of the person were to be dynamically moved closer to the user without size rescaling, the person may grow very large from the user's point of view. This is because both the display of the virtual object moves closer to the user and the person grows larger (e.g., a larger proportion of the virtual object depicts the person's face/body). The virtual object position manager can dynamically resize the two-dimensional virtual object when moving the object along the angular axis to manage the virtual object's relative size from the user's perspective. For example, the virtual object can be scaled down in size when the displayed virtual object is dynamically moved closer to the user and the virtual object can be scaled up in size when the displayed virtual object is dynamically moved further from the user.

A contextual dimming system can assess one or more contexts for an activity engaged in by a user of an XR imaging device, and then selectively adjust, according to the assessment(s), illumination for the image. In particular, the contextual dimming system can, for the user's activity, receive a corresponding indication (e.g., a motion signal, an audible signal, visual indicators, etc.). As a result of receiving the indication, the system can then evaluate, for the indication, a corresponding context, such as whether the user is walking, running, carrying out a conversation with another individual in a same space, etc. Using one or more contexts for the user's activity, the contextual dimming system can then select an adjusted amount of lighting for the image so that the image can still be adequately viewed by the user. By then outputting the adjusted amount of lighting to the image, the system can ensure that an appropriate amount of lighting is provided to enable the user's activity to be carried out efficiently while still being able to view the image.

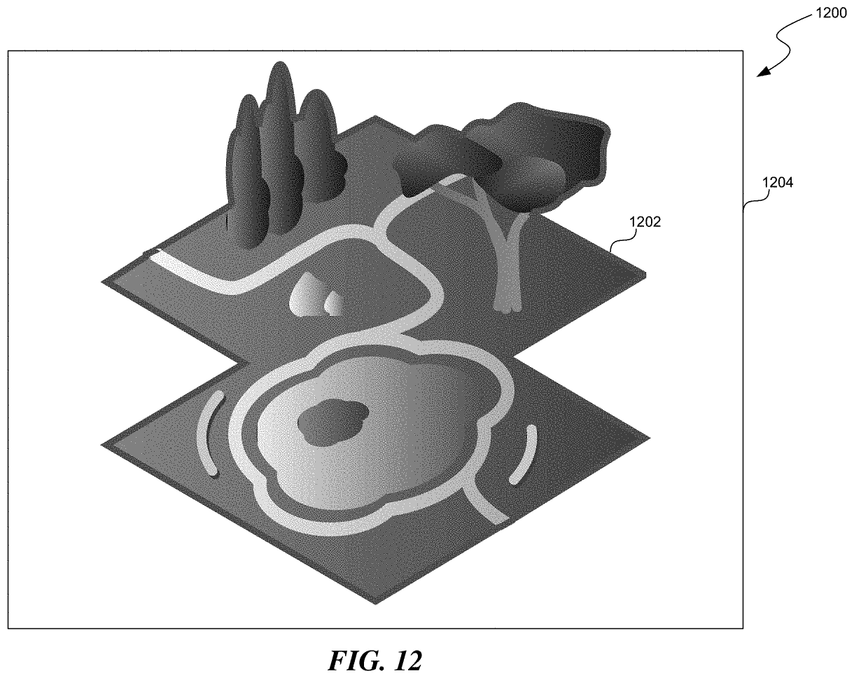

FIG. 12 is a conceptual diagram 1200 illustrating an exemplary XR image in a first contextual dimming scenario. Here, the XR image 1202 corresponds to a park environment illuminated according to a maximum brightness in the XR device's field of view 1204—e.g., a context of being outside and standing still, which is mapped to the maximum brightness level.

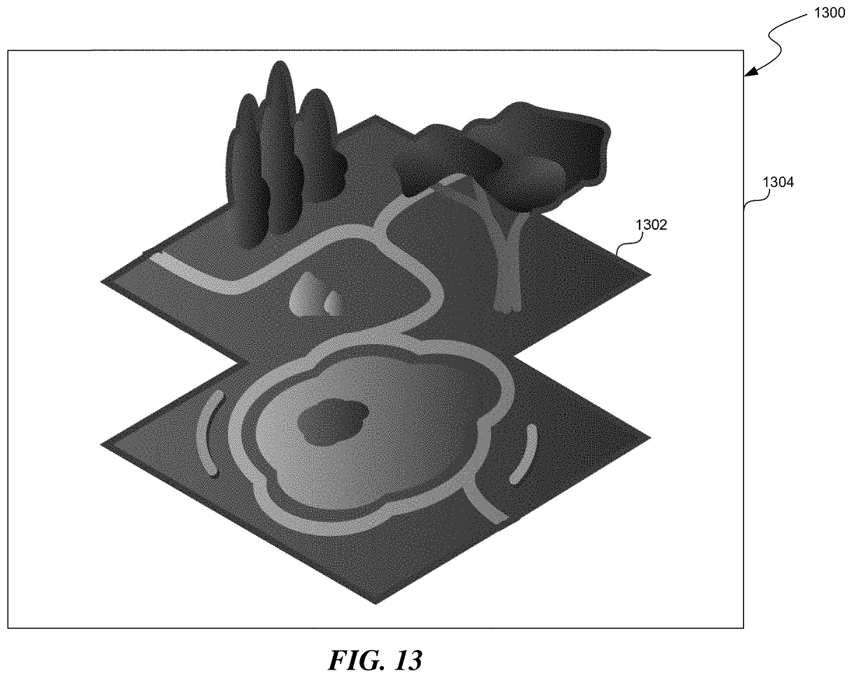

FIG. 13 is a conceptual diagram 1300 illustrating an exemplary XR image in a second contextual dimming scenario. Here, the XR image 1302 corresponds to a park environment in the XR device's field of view 1304—e.g., a context of being outside and walking, which is mapped to the lower brightness level allowing the user to see move of the real-world while moving. By comparison, therefore, FIG. 13 illustrates the illumination in the park environment according to an amount of energy expenditure that is less than that required to obtain the maximum brightness level discussed above. In this way, the contextual dimming system according to implementations of the present technology can effect conservation of energy supplies depending on one or more contexts that can be applicable for an activity of a user of an XR imaging device.

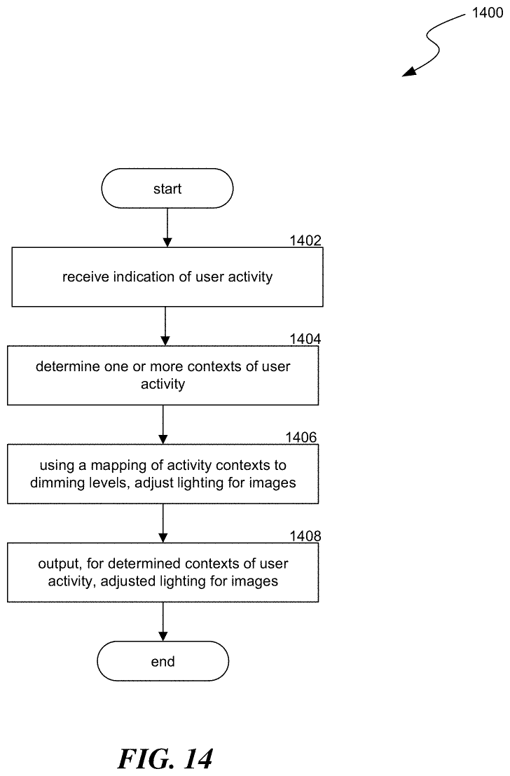

FIG. 14 is a flow diagram illustrating a process 1400 used in some implementations for conserving energy for an XR device according to one or more contexts of user activity associated with that device. Process 1400 can be initiated in response to a user of the XR device engaging in an activity for an XR environment. One or more portions of process 1400 can be performed according to an application that can be executed on a server system, e.g., a system serving various scenes for the XR environment. Alternatively, one or more portions of process 1400 can be performed on a client device, e.g., a pair of XR glasses, or an XR headset in communication with the server executing the contextual dimming system as part of an application for the XR environment.

At block 1402, process 1400 can receive an indication of user activity. In this regard, the indication can be one or more various signals that can be detected by an XR device (e.g., an XR headset or XR glasses). A non-exhaustive list of such signals can include those which relay motion, sound, images, wireless signals, etc. As can be appreciated, process 1400 can receive the indication via one or more sensors (e.g., an accelerometer) integrated with the XR device.

At block 1404, process 1400 can determine one or more contexts for the user activity. Here, the contexts can describe one or more particular types of the user activity corresponding to the one or more signals for activity received at block 1402. That is, a particular context for a motion signal can be that the user is walking, running, driving a vehicle, etc. For example, a machine learning model can be trained to take the available signals and provide one or more corresponding contexts. For example, certain motions can be mapped by the model to walking, running, or driving. As another example, certain visual and/or audio indicators can be mapped to types of environments such as being outside or inside, being in high light or low light, being alone or in a group with others, etc. More specifically, a context for a signal relaying sound activity for the user can indicate that the user is engaged in conversation with another individual occupying a same space as the user. As yet another example, a signal from another device can indicate whether there are other devices for other users in the near vicinity. In these and other instances, process 1400 can determine specifically applicable contexts for user activity according to measurements for the signals (e.g., accelerometer readings per predetermined time intervals, differing decibel and pitch readings for conversations), as detected by the XR device at block 1402. Alternatively or in addition to the above contexts, process 1400 can determine that a context for user activity can be a specific lighting condition throughout which interaction with the XR device takes place. For instance, such a lighting condition can be a level of ambient lighting detected by one or more light sensors of the XR device.

A “machine learning model” or “model” as used herein, refers to a construct that is trained using training data to make predictions or provide probabilities for new data items, whether or not the new data items were included in the training data. For example, training data for supervised learning can include positive and negative items with various parameters and an assigned classification. Examples of models include: neural networks (traditional, deep, convolution neural network (CSS), recurrent neural network (RNN)), support vector machines, decision trees, decision tree forests, Parzen windows, Bayes, clustering, reinforcement learning, probability distributions, decision trees, and others. Models can be configured for various situations, data types, sources, and output formats. In some implementations, the model trained to identify the one or more contexts can be trained using supervised learning where input signals have been mapped to known contexts, such that representations of the signals are provided as inputs to the model and the model provides an output that can be specified as one or more contexts which can be compared to the known contexts for the signals and, based on the comparison, the model parameters can be updated. For example, the model parameters can include changing weights between nodes of a neural network or parameters of the functions used at each node in the neural network (e.g., applying a loss function). After applying each of the pairings of the inputs (signal indicators) and the desired output (context determinations) in the training data and modifying the model in this manner, the model is trained to evaluate new instances of XR context signals to determine context labels.

At block 1406, process 1400 can, using a mapping of activity contexts to dimming levels, adjust lighting for images output by an XR device. Here, the mapping can correlate particular degrees of dimming to contexts so that activities categorized for contexts can be effectively and purposefully conducted. In other words, a specific context for an activity can trigger how much or how little outputted images are dimmed. In some cases, process 1400 can regulate dimming levels for images according to a predetermined dimming threshold. For instance, process 1400 can restrict dimming to not exceed the threshold. In a first case, such restrictive dimming can be applicable for images output to an XR device user when the context for a user's activity involves motion (walking, running, driving, etc.). This way, process 1400 can ensure that the underlying motive activity can be efficiently and safely executed. In a second instance where it is determined that a user is undertaking a conversation with another individual, process 1400 can selectively dim images output to the user according to a level that is less than a magnitude for the dimming threshold. This way, process 1400 can ensure that the user can maintain dual foci (i.e., output images and the conversation) without being unduly distracted by an inordinate amount of dimming. In still another example, images output to a user can be similarly dimmed (i.e., below the threshold) by process 1400 according to contexts for activities, such as whether a user is viewing external display devices (i.e., a television, a monitor). In some cases, illumination for images output to the user via the XR device can be controlled by process 1400 to a level beneath the threshold as a result of tracking the user's eye movement or gauging a viewing distance for the user. By contrast, such a restriction can be lifted to thus allow dimming to occur at a level above the predetermined dimming threshold when process 1400 determines that a context for a user's activity does not involve motion (e.g., the user is sitting or standing in place). In one or more of the above cases, process 1400 can scale implementation for applicable dimming for images according to a level of ambient light (e.g., greater dimming if ambient light is plentiful versus lesser dimming if ambient light is scarce). That is, the predetermined threshold can be adjusted when process 1400 detects the influence of ambient lighting for outputted images.

At block 1408, process 1400 can output, for determined contexts of user activity, adjusted lighting for images. In this way, process 1400 can optimize conservation of energy expended in displaying such images.

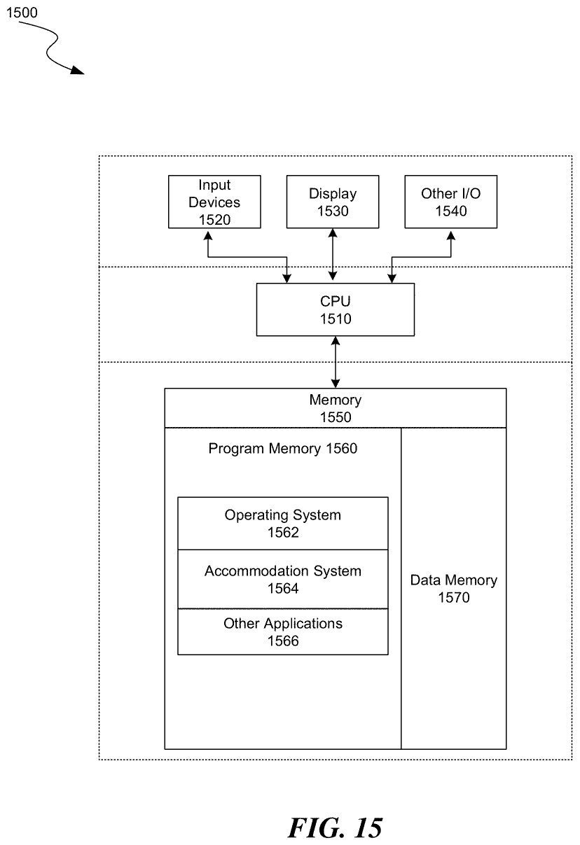

FIG. 15 is a block diagram illustrating an overview of devices on which some implementations of the disclosed technology can operate. The devices can comprise hardware components of a device 1500 as shown and described herein. Device 1500 can include one or more input devices 1520 that provide input to the Processor(s) 1510 (e.g., CPU(s), GPU(s), HPU(s), etc.), notifying it of actions. The actions can be mediated by a hardware controller that interprets the signals received from the input device and communicates the information to the processors 1510 using a communication protocol. Input devices 1520 include, for example, a mouse, a keyboard, a touchscreen, an infrared sensor, a touchpad, a wearable input device, a camera- or image-based input device, a microphone, or other user input devices.

Processors 1510 can be a single processing unit or multiple processing units in a device or distributed across multiple devices. Processors 1510 can be coupled to other hardware devices, for example, with the use of a bus, such as a PCI bus or SCSI bus. The processors 1510 can communicate with a hardware controller for devices, such as for a display 1530. Display 1530 can be used to display text and graphics. In some implementations, display 1530 provides graphical and textual visual feedback to a user. In some implementations, display 1530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 1540 can also be coupled to the processor, such as a network card, video card, audio card, USB, firewire or other external device, camera, printer, speakers, CD-ROM drive, DVD drive, disk drive, or Blu-Ray device.

In some implementations, the device 1500 also includes a communication device capable of communicating wirelessly or wire-based with a network node. The communication device can communicate with another device or a server through a network using, for example, TCP/IP protocols. Device 1500 can utilize the communication device to distribute operations across multiple network devices.

The processors 1510 can have access to a memory 1550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 1550 can include program memory 1560 that stores programs and software, such as an operating system 1562, Accommodation System 1564, and other application programs 1566. Memory 1550 can also include data memory 1570, which can be provided to the program memory 1560 or any element of the device 1500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

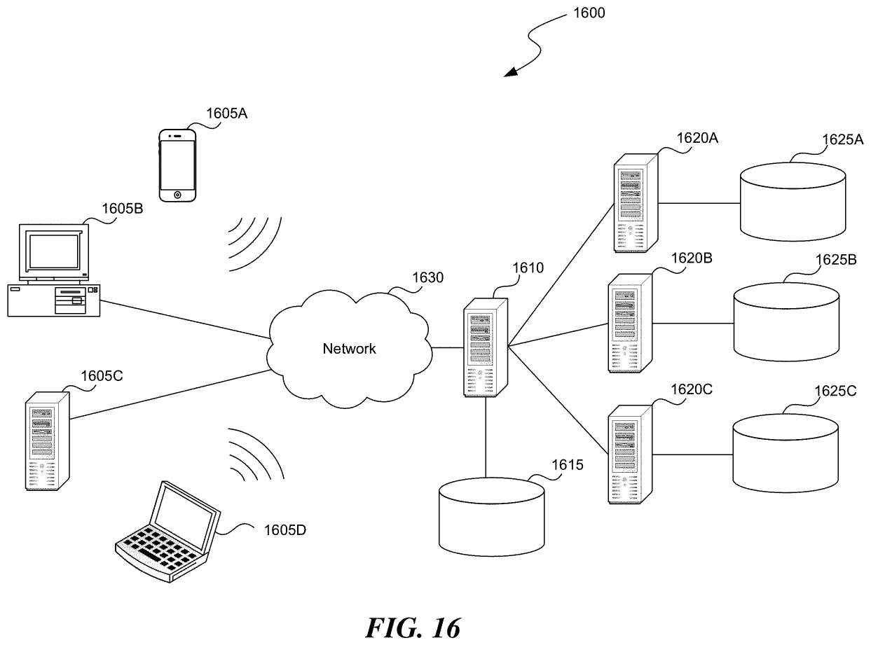

FIG. 16 is a block diagram illustrating an overview of an environment 1600 in which some implementations of the disclosed technology can operate. Environment 1600 can include one or more client computing devices 1605A-D, examples of which can include device 1500. Client computing devices 1605 can operate in a networked environment using logical connections through network 1630 to one or more remote computers, such as a server computing device.

In some implementations, server 1610 can be an edge server which receives client requests and coordinates fulfillment of those requests through other servers, such as servers 1620A-C. Server computing devices 1610 and 1620 can comprise computing systems, such as device 1500. Though each server computing device 1610 and 1620 is displayed logically as a single server, server computing devices can each be a distributed computing environment encompassing multiple computing devices located at the same or at geographically disparate physical locations. In some implementations, each server 1620 corresponds to a group of servers.

Client computing devices 1605 and server computing devices 1610 and 1620 can each act as a server or client to other server/client devices. Server 1610 can connect to a database 1615. Servers 1620A-C can each connect to a corresponding database 1625A-C. As discussed above, each server 1620 can correspond to a group of servers, and each of these servers can share a database or can have their own database. Databases 1615 and 1625 can warehouse (e.g., store) information. Though databases 1615 and 1625 are displayed logically as single units, databases 1615 and 1625 can each be a distributed computing environment encompassing multiple computing devices, can be located within their corresponding server, or can be located at the same or at geographically disparate physical locations.

Network 1630 can be a local area network (LAN) or a wide area network (WAN), but can also be other wired or wireless networks. Network 1630 may be the Internet or some other public or private network. Client computing devices 1605 can be connected to network 1630 through a network interface, such as by wired or wireless communication. While the connections between server 1610 and servers 1620 are shown as separate connections, these connections can be any kind of local, wide area, wired, or wireless network, including network 1630 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021 and now issued as U.S. Pat. No. 11,402,964 on Aug. 2, 2022, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for degrading output graphics to conserve resources on an XR system, the method comprising:
facilitating display of graphics on the XR system;
determining a current graphics load on the XR system based on the graphics being displayed;
identifying a trigger related to the current graphics load on the XR system;
selecting a degradation, corresponding to the trigger, to be applied to the graphics;
modifying the graphics according to the degradation; and
outputting the modified graphics.

2. A method for dynamically positioning a virtual object display in response to detected motion, the method comprising:
displaying, in an artificial reality environment to a user, a virtual object at a first distance along an angular axis from the user, wherein the displayed virtual object corresponds to captured video of an object and the first distance corresponds to the object's position in the captured video; and
dynamically moving the displayed virtual object closer to or further from the user in response to a change in the object's position in the captured video, wherein dynamically moving the virtual object increases or decreases the first distance along the angular axis.

3. A method for conserving energy in artificial reality, the method comprising:
receiving an indication of activity of a user, who is wearing an artificial reality device, wherein the artificial reality device outputs images to the user;
determining one or more contexts for the activity;
based on the one or more contexts for the activity, selecting an adjusted amount of lighting for the images according to a mapping of activity contexts to dimming levels; and
outputting, for the one or more contexts for the activity, the adjusted amount of lighting to the images.
